(19) United States
(12) Patent Application Publication
(10) Pub. No.: US 2008/0244955 A1
(43) Pub. Date: Oct. 9, 2008

(54) BAIT SPEED LOADER

(76) Inventor: Virgil Wilson, Howell, MI (US)

Correspondence Address: VIVACQUA LAW, PLLC, 455 East Eisenhower Parkway, Suite 11, ANN ARBOR, MI, 48108, US

(21) Appl. No.: 11/733,160

(22) Filed: Apr. 9, 2007

(51) Int. Cl. A01K 97/00

(52) U.S. Cl. 43/4

(57) ABSTRACT

A device for attaching an elastic band to a lure having a narrowed end is provided. The device includes a body portion for supporting the elastic band. A cavity is defined in the body portion. An open end leads to the cavity for receiving the lure. The cavity has a first diameter at a first distance from the open end and a second diameter at a second distance from the open end. The first diameter is greater than the second diameter and the first distance is less than the second distance. The first diameter is approximately equal to a diameter of the lure and the second diameter is approximately equal to a diameter of the lure at the narrowed end.

### FIELD

The present disclosure relates to a device used in fishing, and more particularly to devices for preparing fishing lures or bait.

### BACKGROUND

The statements in this section merely provide background information related to the present disclosure and may or may not constitute prior art.

Many types of lures or bait are used in fishing, ranging from live bait such as worms or other insects, to synthetic polymer products designed to attract fish. One popular lure is a polymer worm known as a stick worm, such as the one offered by Custom Baits of Page, Ariz., and offered under the name Senko. A stick worm has a flexible cylindrical body that mimics the shape of a worm. In order to maximize its appeal to fish, the lure is preferably attached to a fishing line at the center of the lure.

In the past, a hook was inserted through the body of the lure. However, this method of securing the lure to the line has its disadvantages. First, the lure becomes permanently damaged when the hook pierces the body of the lure. Accordingly, the lure must be replaced as often as every use. Additionally, because the lure's body has been pierced, the lure loses strength and may fall off the hook and line during casting.

One solution to this problem is to attach an o-ring to the body of the lure. The hook is then inserted though the o-ring, thereby avoiding piercing the body of the lure. While effective, the o-ring can be difficult to attach to the worm. Specifically, the o-ring must be rolled onto the lure, and due to the flexible nature of the lure, the lure may be stretched or ripped during this process. Stretching of the lure can lead to discoloration which is undesirable. Accordingly, there is room in the art for a bait speed loader that can quickly and efficiently attach an o-ring to a lure without damaging the lure.

### SUMMARY

The present invention provides a device for attaching an elastic band to a lure having a narrowed end. The device includes a body portion for supporting the elastic band. A cavity is defined by the body portion. An open end leads to the cavity for receiving the lure. The cavity has a first diameter at a first distance from the open end and a second diameter at a second distance from the open end. The first diameter is greater than the second diameter and the first distance is less than the second distance. The first diameter is approximately equal to a diameter of the lure and the second diameter is approximately equal to a diameter of the lure at the narrowed end.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a side view of an exemplary first lure employed with the present invention;

FIG. 1B is a side view of an exemplary second lure employed with the present invention;

FIG. 2 is a side cross-sectional view of a loader according to the principles of the present invention;

FIG. 3 is a side cross-sectional view of the first lure and the loader of the present invention;

FIG. 4 is a side cross-sectional view of the second lure and the loader of the present invention;

FIG. 5 is a side view of the second lure after application of an o-ring employed with the present invention; and

FIG. 6 is a side view of a second embodiment of a loader according to the principles of the present invention.

### DETAILED DESCRIPTION

The following description is merely exemplary in nature and is not intended to limit the present disclosure, application, or uses.

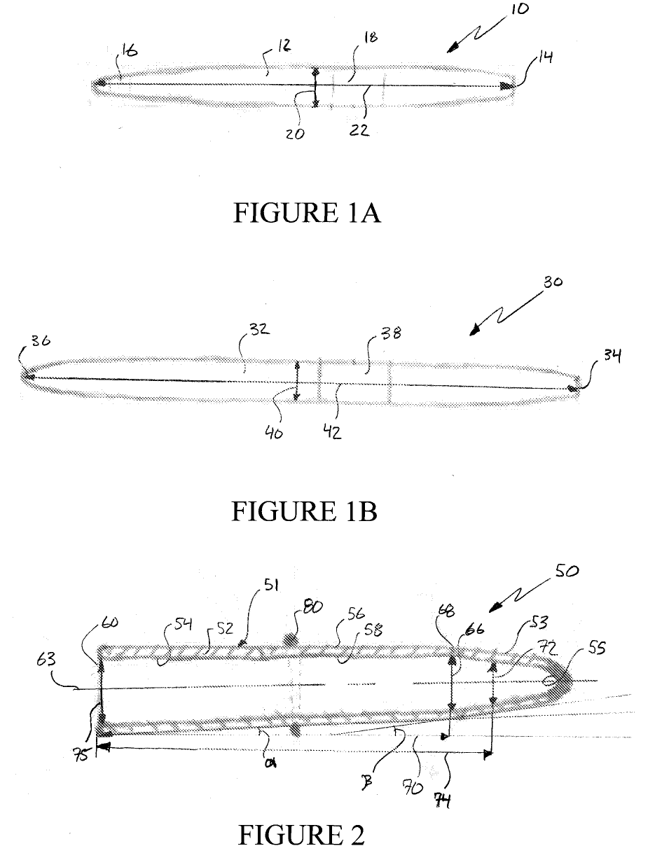

With reference to FIG. 1A, an exemplary lure used with the present invention is indicated by reference number 10. The lure 10 is intended to represent a worm, and accordingly includes a generally cylindrical body 12 with a blunt end 14 and a narrowed end 16. The lure 10 also includes a smooth section 18 intended to represent an egg sac on a typical worm. The cylindrical body 12 has a first diameter indicated by reference number 20. The lure 10 has a first length indicated by reference number 22 measured from the blunt end 14 to the narrowed end 16. The lure 10 is preferably flexible and made from a polymer. The lure 10 may include various substances such as salts or colored material imbedded in the polymer in order to increase the appeal of the lure 10 to fish.

A second exemplary lure 30 is shown in FIG. 1B. The second lure 20 is substantially similar to the first lure 10 and includes a cylindrical body 32, a blunt end 34, a narrowed end 36, and a smooth portion 38. The cylindrical body 32 has a second diameter indicated by reference number 40 and a second length indicated by reference number 42 measured from the blunt end 34 to the narrowed end 36. However, the second lure 30 has different dimensions than the first lure 10. More specifically, the first length 22 is less than the second length 42. In the particular example provided, the first length 22 is approximately four inches and the second length 42 is approximately five inches.

Turning now to FIG. 2, a loader according to the principles of the present invention is shown and generally indicated by reference number 50. As will be described in greater detail below, the loader 50 is used to quickly prepare the exemplary lures 10 and 30 illustrated in FIGS. 1A and 1B. The loader 50 generally includes an elongated body 51. The body 51 includes a main portion 52 and a closed end or portion 53 that both help define a cavity 54. Accordingly, the body 51 has an exterior wall or outer surface 56 and an interior wall or inner surface 58. The closed portion 53 includes an inner end surface 55 at the apex or end of the cavity 54. The main portion 52 is preferably frusto-conical as will be described in greater detail below, though it should be appreciated that the main portion 52 may have various other shapes such as cylindrical. The body 51 also includes an open end or portion 60 that communicates with the cavity 54. The main portion 52 and the closed portion 53 are symmetrical about a central axis indicated by reference number 63.

The loader 50 includes a first inner diameter indicated by reference number 66 that defines the diameter of the inner surface 54 at a joint location 68 where the main portion 52 meets the closed portion 53. The joint location 68 is set at a first predefined distance 70 from the open end 60. A second inner diameter indicated by reference number 72 defines the diameter of the inner surface 54 at a location within the closed portion 53 at a set second predefined distance 74 from the open end 60. This second distance 74 may be such that the second diameter 72 is located at the inner end surface 55. A third inner diameter indicated by reference number 75 defines the diameter of the inner surface 54 at the open end 60. The third inner diameter 75 is greater than the first inner diameter 64 which is greater than the second inner diameter 66. As will be described in greater detail below, the inner diameters 66, 72, 75 cooperate to locate and position the lures 10 and 30 within the cavity 54.

The outer surface 56 of the main portion 52 and the closed portion 53 is sloped or tapered with respect to the axis 63. More specifically, the outer surface 56 of the main portion 52 is sloped at a first slope angle a with respect to the axis 63 and the outer surface of the closed portion 53 is sloped at a second slope angle β with respect to the axis 63. The first slope angle α is less than the second slope angle β. In other words, the closed portion 53 has a steeper slope than the main portion 52. In the particular example provided, the first slope angle α is approximately between 1 and 3 degrees and the second slope angle β is approximately between 21 to 27 degrees. Additionally, in the particular example provided, the main portion 52 and the closed portion 53 have a constant wall thickness between the inner surface 54 and the outer surface 56. Accordingly, the sloping or tapering of the outer surface 56 at the main portion 52 and the closed portion 53 is carried over to the inner surface 54.

In the particular example provided, the loader 50 is made from a plastic compound and is a single unitary piece. This allows the loader 50 to float if dropped in water. However, it should be appreciated that the loader 50 may be made from various other materials or in joined discrete pieces without departing from the scope of the present invention.

An elastic band or o-ring 80 is intended to be carried on the main portion 52. While in the particular example provided a single elastic band 80 is illustrated, it should be appreciated that any number of elastic bands 80 may be carried on the main portion 52 without departing from the scope of the present invention. The elastic band 80 has a static or rest diameter that is less than the diameters 20, 40 of the lures 10, 30, thereby assuring that the elastic band 80 grips the lures 10, 30 when located thereon. Additionally, the static diameter of the elastic band 80 assures that when the elastic band 80 is located on the main portion 52, the elastic band 80 will grip the main portion 52 and resist falling off the loader 50. The sloped outer surface 56 at the closed portion 53 of the loader 50 assists loading of elastic bands 80 onto the loader 50 by allowing the elastic bands 80 to simply be rolled onto the loader 50 rather than being stretched prior to loading. The elastic band 80 is preferably circular in shape and made from an elastic material such as rubber, though it should be appreciated that various shapes and materials may be employed without departing from the scope of the present invention.

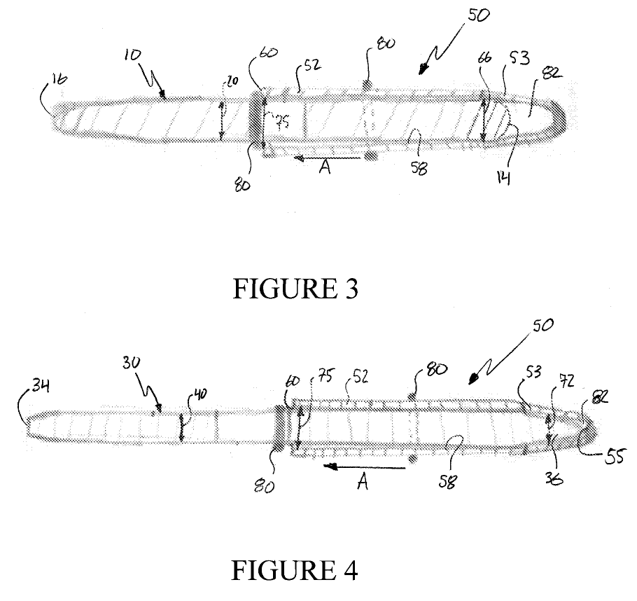

With reference to FIG. 3, the operation of the loader 50 with the first lure 10 will now be described. First, the loader 50 is loaded with at least one elastic band 80 by positioning the elastic band over the closed portion 53 and rolling or sliding the elastic band 80 onto the main portion 52. Next, the blunt end 14 of the lure 10 is inserted into the open end 60 of the loader 50 and into the cavity 54. In this sense, the third diameter 75 of the loader 50 is greater than the diameter 20 of the lure 10 to allow the lure 10 to enter the cavity 54 without compressing the lure 10. The lure 10 is inserted into the cavity 54 until stopped by the inner surface 58 of the loader 50. This occurs at approximately the location of the first inner diameter 66 where the first inner diameter 66 approximately equals the outer diameter 20 of the lure 10. Additionally, a pocket of air 82 forms within the cavity 54 between the lure 10 and the closed portion 53 that serves to help stop the lure 10. The lure 10 is stopped such that approximately half the length 22 of the lure 10 is inside the loader 50 and half the length 22 of the lure 10 is outside the loader 50. Next, an elastic band 80 is rolled or slid towards the open end 60 in the direction of the arrow indicated by reference letter “A” until such time as the elastic band 80 rolls or is slid off the loader 50 and onto the lure 10.

With reference to FIG. 4, the operation of the loader 50 with the second lure 30 will now be described. First, the loader 50 is loaded with at least one elastic band 80 by positioning the elastic band over the closed portion 53 and rolling the elastic band 80 onto the main portion 52. Next, the narrowed end 36 of the lure 30 is inserted into the open end 60 of the loader 50 and into the cavity 54. In this sense, the third diameter 75 of the loader 50 is greater than the diameter 40 of the lure 30 to allow the lure 30 to enter the cavity 54 without compressing the lure 30. The lure 30 is inserted into the cavity 54 until stopped by the inner surface 58 of the loader 50. This occurs at approximately the location of the second inner diameter 72 where the inner surface 58 engages the narrowed end 36 of the lure 30. Additionally, a pocket of air 82 forms within the cavity 54 between the lure 30 and the closed portion 53 that serves to help stop the lure 30. Alternatively, the lure 30 may be stopped when the lure 30 contacts the inner end surface 55. The lure 30 is stopped such that approximately half the length 42 of the lure 30 is inside the loader 50 and half the length 42 of the lure 30 is outside the loader 50. Next, an elastic band 80 is rolled or slid towards the open end 60 in the direction of the arrow indicated by reference letter “A” until such time as the elastic band 80 rolls off the loader 50 and onto the lure 30.

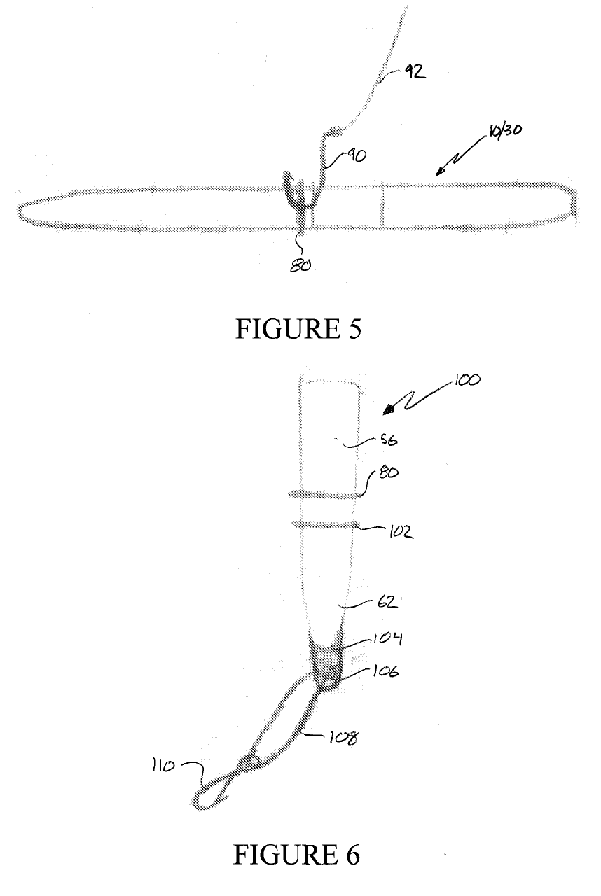

Turning now to FIG. 5, once either lure 10 or 30 has been loaded with an elastic band 80, the lures 10, 30 are removed from the loader 50. The loader 50 operates to position the elastic band 80 in the approximate center of the lures 10, 30 irrespective of what size lure 10, 30 has been used with the loader 50. A hook 90 coupled to a fishing line 92 may then be attached to the elastic band 80. This allows the lures 10, 30 to be baited without piercing or damaging the lures 10, 30.

With reference to FIG. 6, a second embodiment of the loader is generally indicated by reference number 100. The loader 100 is substantially similar to the loader 50, however, the loader 100 includes several additional features. First, the loader 100 includes a retention feature 102 located proximate to the closed portion 53. The retention feature 102 operates to prevent the elastic bands 80 from sliding off the loader 100. In the particular example provided, the retention feature 102 is an annular riser having a semi-circular cross-section to allow the elastic band 80 to roll over top the retention feature 102 when loading the loader 100 with elastic bands 80. However, the retention feature 102 may take other forms, such as a discrete molded bump, without departing from the scope of the present invention.

The loader 100 also includes an extension 104 that extends out from the closed portion 53. The extension 104 includes a hole 106. The hole 106 extends through the extension 104 from one side thereof to an opposite side thereof. The extension 104 and hole 106 cooperate to allow any number of devices to be coupled to the loader 100. In the particular example provided, a lanyard string 108 having a belt clasp 110 extends through the hole 106, however, it should be appreciated that any number of devices may be coupled to the extension 104 and the hole 106 without departing from the scope of the present invention. Additionally, the above described loaders 50, 100 may be included as a bait loading system having one or more of the exemplary lures 10, 30 and a plurality of elastic bands 80.

The description of the invention is merely exemplary in nature and variations that do not depart from the gist of the invention are intended to be within the scope of the invention. Such variations are not to be regarded as a departure from the spirit and scope of the invention.

What is claimed is:

1. A device for locating an elastic band on a lure having a narrowed end, the device comprising:
an elongated body having an interior wall that defines a cavity, the cavity having an open end for receiving the lure;
wherein the cavity has a first diameter at a first distance from the open end and a second diameter at a second distance from the open end, the first diameter greater than the second diameter and the first distance greater than the second distance; and
wherein the first diameter is approximately equal to a diameter of the lure and the second diameter is approximately equal to a diameter of the lure at the narrowed end.

2. The device of claim 1 wherein the elongated body has a main portion and a closed portion opposite the open end.

3. The device of claim 2 wherein the second diameter is located proximate to the closed portion.

4. The device of claim 3 wherein the first diameter is located at the junction between the body portion and the closed portion.

5. The device of claim 4 wherein the device has a central axis, and the body portion has an outer surface having a first slope relative to the central axis.

6. The device of claim 5 wherein the closed portion has an outer surface having a second slope relative to the central axis.

7. The device of claim 6 wherein the second slope is greater than the first slope.

8. The device of claim 7 wherein the cavity is sloped at the first slope in the body portion and sloped at the second slope in the closed portion.

9. The device of claim 8 wherein the main portion is frusto-conical.

10. The device of claim 2 further comprising a retaining feature located on the body portion proximate the closed portion to retain the elastic band on the body portion.

11. The device of claim 10 wherein the retaining feature is an annular riser.

12. The device of claim 2 further comprising an extension extending out from the closed portion, the extension having a hole for receiving a line and a belt clasp.

13. The device of claim 1 wherein the second diameter is located at an inner end surface of the cavity.

14. The device of claim 1 wherein the cavity includes a third diameter at the open end, wherein the third diameter is greater than the diameter of the lure.

15. A system for preparing a lure having a narrowed end, the system comprising:
an elastic band; and
a loading member having an elongated body that has a central axis, the elongated body having a body portion having an outer surface at a first slope with respect to the central axis and a closed end portion adjacent the body portion, the closed end portion having an outer surface having a second slope with respect to the central axis, wherein the second slope is greater than the first slope, the elongated body defining a cavity having an open end for receiving the lure, and
wherein the elastic band is supported by the body portion and is moveable onto the lure from the body portion of the loading member when the lure is inserted into the cavity.

16. The system of claim 15 wherein the cavity has a first diameter at the junction of the body portion and the closed end portion and a second diameter proximate to the closed end portion, and wherein the first diameter is greater than the second diameter.

17. The system of claim 16 wherein the first diameter is approximately equal to a diameter of the lure and the second diameter is approximately equal to a diameter of the lure at the narrowed end.

18. A method for preparing a lure comprising the steps of:
inserting the lure into an open end of a loading member, the loading member having a cavity that has a first inner diameter and a second inner diameter;
positioning the lure into the cavity until the lure contacts one of the first inner diameter or the second inner diameter;
moving an elastic band from the loading member to the lure to position the elastic band approximately in the center of the lure; and
removing the lure from the loading member.

19. The method of claim 18 further comprising the steps of loading the elastic band onto the loading member.

20. The method of claim 19 wherein the step of loading the elastic band onto the loading member includes the steps of positioning the elastic band over a tapered closed portion and rolling the elastic band onto a portion of the loading member.
